(19) United States
(12) Patent Application Publication
(10) Pub. No.: US 2023/0402637 A1
(43) Pub. Date: Dec. 14, 2023

(54) FUEL CELL SYSTEM OF A MOTOR VEHICLE, AND MOTOR VEHICLE COMPRISING A FUEL CELL SYSTEM

(71) Applicant: Robert Bosch GmbH, Stuttgart (DE)

(72) Inventors: Dirk Schnittger, Ludwigsburg (DE); Rolf-Peter Essling, Reudern (DE); Tobias Korte, Walddorfhaeslach (DE)

(21) Appl. No.: 18/250,401

(22) PCT Filed: Oct. 20, 2021
(86) PCT No.: PCT/EP2021/079033

§ 371 Date: Apr. 25, 2023

(30) Foreign Application Priority Data
Oct. 28, 2020 (DE) 10 2020 213 528.2

(51) Int. Cl. H01M 8/2475; H01M 8/1041

(52) U.S. Cl. CPC H01M 8/2475; H01M 8/1041; H01M 2250/20; H01M 2008/1095

(57) ABSTRACT

The invention relates to a fuel cell system (100) of a motor vehicle (200), wherein the fuel cell system (100) comprises:
at least one fuel cell stack (90a, 90b), and
a housing (1) with a housing body (10) for receiving the at least one fuel cell stack (90a, 90b), wherein the housing body (10) has:
   at least one motor vehicle securing section (22a, 22b),
   at least one system module securing section (32a, 32b, 32c, 32d) on the exterior of a housing wall (12, 13, 14, 15, 16, 17) of the housing body (10) for arranging at least one system module (50a, 50b, 50c, 50d), and
the at least one system module (50a, 50b, 50c, 50d), wherein the at least one system module (50a, 50b, 50c, 50d) is connected to the at least one fuel cell stack (90a, 90b) so as to communicate therewith.

### BACKGROUND

A fuel cell is an electrochemical cell, wherein the latter has two electrodes separated from one another by means of an ion-conducting electrolyte. The fuel cell converts the energy of a chemical reaction of a fuel directly into electricity using an oxidizing agent. Various types of fuel cells exist.

A specific fuel cell type is, in particular, the polymer electrolyte membrane fuel cell (PEM-FC). In an active area of the PEM-FC, a porous electrode having a catalyst layer borders a side of the polymer electrolyte membrane (PEM), and a further porous electrode having a catalyst layer borders a further side of the PEM opposite said side of the PEM. In the active region, the PEM-FC further comprises gas diffusion layers (GDL) which border, on both sides, the PEM and the two porous electrodes having the respective catalyst layer. The PEM, the two electrodes having the respective catalyst layer, and the two GDL form a so-called membrane-electrode unit (MEA) in the active region of the PEM-FC. Two bipolar plates in turn border the MEA on both sides, wherein the MEA and the two bipolar plates form in particular a single fuel cell. A fuel cell stack is constructed of MEAs and bipolar plates alternately arranged one above the other and thus comprises a plurality of individual fuel cells.

The fuel cell stack can be used in a motor vehicle, such as a passenger motor vehicle or a freight truck, to generate electrical energy for driving the motor vehicle, in particular for driving an electric drive motor of the motor vehicle. To generate the electrical energy in the fuel cell stack, system modules, such as a fuel supply module for supplying fuel to the fuel cell stack and an oxidizer supply module for supplying an oxidizer to the fuel cell stack, are required in or on the motor vehicle.

From DE102009052440A1, a fuel cell system or fuel cell arrangement for a motor vehicle having at least two fuel cell stacks is known. The at least two fuel cell stacks are arranged within a common housing along with further modules, such as an air supply module.

A fuel cell system, in particular an arrangement of a fuel cell system in or on a motor vehicle, is constantly optimizable.

### SUMMARY

The present invention discloses a fuel cell system of a motor vehicle as well as a motor vehicle having such a fuel cell system.

Further features and details of the invention arise from the description and the drawings. Of course, features and details described in connection with the fuel cell system according to the invention also apply in connection with the motor vehicle according to the invention, and respectively vice versa, so that with respect to the disclosure, mutual reference to the individual aspects of the invention is or can always be made.

According to a first aspect, the present invention discloses a fuel cell system of a motor vehicle, wherein the fuel cell system
comprises at least one fuel cell stack having a plurality of fuel cells and a housing having a housing body for receiving and protecting the at least one fuel cell stack. The at least one fuel cell stack with the plurality of fuel cells is in particular received and protected in the housing body. The housing body further comprises at least one motor vehicle securing section for arranging the housing body on a body of the motor vehicle. Furthermore, the housing body comprises at least one system module securing section on the exterior of a housing wall of the housing body for arranging at least one system module. The fuel cell system also comprises the at least one system module having a system module counter-securing section, wherein the at least one system module having the system module counter-securing section is arranged on the at least one system module securing section of the housing body at least partially on the exterior of the housing wall of the housing body, wherein the at least one system module is connected to the at least one fuel cell stack so as to communicate therewith.

In particular, the housing body of the housing of the fuel cell system forms an internal space in which the at least one fuel cell stack is received and protected. Furthermore, the at least one fuel cell stack housed in the internal space is received in the housing body such that the at least one fuel cell stack fills at least 40%, preferably at least 60%, particularly at least 80%, of the internal space formed by the housing body. The housing body and thus the fuel cell system can thus be particularly compact. Preferably, the housing body can be cuboid or box-shaped. The cuboid or box-shaped housing body in particular forms the internal space for receiving and protecting the at least one fuel cell stack.

The exterior of a housing wall of the housing body is to be understood in particular as the side of the housing wall which faces away from the at least one fuel cell stack received in the housing body. The inner side of the housing wall of the housing body is to be understood in particular as the side of the housing wall which faces the at least one fuel cell stack received in the housing body.

The at least one fuel cell stack is in particular arranged on the housing body such that the at least one fuel cell stack stiffens the housing body. For example, to stiffen the housing body, the at least one fuel cell stack can be arranged in at least one location of the housing body. It is also conceivable that, for the stiffening of the housing body, the at least one fuel cell stack is arranged on the housing body in at least two locations, in particular at two opposite locations. Preferably, the at least one fuel cell stack is arranged on the housing body in at least four locations, wherein the at least four locations are evenly distributed over the housing body of the housing.

Furthermore, the at least one fuel cell stack is in particular at least partially releasably received or arranged on the housing body. The at least one fuel cell stack arranged at least partially releasably on the housing body can be arranged at least partially on the housing body in a force-fit or form-fit manner. Preferably, the fuel cell stack is fully releasably received or arranged on the housing body. For example, the fuel cell stack can be arranged fully releasably on the housing body by means of at least one screw connection in a force-fit or form-fit manner.

In particular, the at least one fuel cell stack comprises a stack end plate at the two opposing ends of the fuel cell stack. Thus, the plurality of fuel cells of the at least one fuel cell stack can be particularly advantageously braced by the two opposing stack end plates. A sealing of the at least one fuel cell stack can further be achieved, and the electrical contact between the bipolar plates and the membrane-electrode units of the at least one fuel cell stack can be particularly advantageous. For the bracing, tensile elements can be used, for example.

The at least one fuel cell stack received and protected in the housing body of the housing can also be understood in particular as at least two fuel cell stacks.

The housing body can comprise the at least one motor vehicle securing section, in particular on the exterior of a housing wall of the housing body. Preferably, the housing body can comprise at least one respective motor vehicle securing section on the respective exterior of two opposing housing walls of the housing body. The housing body can thus be arranged particularly advantageously on the body of the motor vehicle. The housing body can further be arranged releasably on the body of the motor vehicle, preferably on at least one motor vehicle counter-securing section of the body of the motor vehicle, by means of the at least one motor vehicle securing section. Thus, the fuel cell system can be assembled and disassembled particularly easily with the housing body or the housing body of the housing. The releasable positioning of the housing body on the body of the motor vehicle is preferably carried out by means of at least one force-fit or form-fit connection, e.g. by means of a screw connection and/or a bolt connection. Furthermore, the housing body, in particular by means of the at least one motor vehicle securing section, can be arranged directly on the body of the motor vehicle, preferably on at least one motor vehicle counter-securing section of the body of the motor vehicle. In other words, the housing body can be arranged on the body of the motor vehicle by way of the at least one motor vehicle securing section, preferably on at least one motor vehicle counter-securing section of the body of the motor vehicle, such that the motor vehicle securing section and the body, preferably the at least one motor vehicle securing section of the body, are at least partially in contact with one another. The motor vehicle or the fuel cell system can thus be particularly cost-efficient, simple, compact, and stable. The housing body can further be arranged, in particular by means of the at least one motor vehicle securing section, indirectly on the body of the motor vehicle, preferably on at least one motor vehicle counter-securing section of the body of the motor vehicle. In other words, the housing body can be arranged on the body of the motor vehicle by means of the at least one motor vehicle securing section via at least one connecting element. The at least one connecting element can be, for example, a carrier and/or a rubber buffer. In particular, the housing can comprise the at least one connecting element. The at least one connecting element can be formed integrally with the housing body of the housing. It is also conceivable that the at least one connecting element and the housing body are configured as separate components, wherein the connecting element is arranged on the housing body, preferably releasably arranged. The releasable arrangement can in particular be carried out by screwing with screws.

By arranging the at least one system module by means of the system module counter-securing section to the at least one system module securing section of the housing body at least partially to the exterior of the housing wall, the convective transport of thermal energy, in particular the natural convection, can be particularly advantageous. Furthermore, thermal radiation from the at least one system module and/or the housing body can also particularly advantageously leave the fuel cell system, because the thermal radiation generated by the system module can be more easily distributed in the fuel cell system or the motor vehicle or the environment. The at least one system module can in particular be arranged at least partially on the exterior of the housing wall of the housing body such that the at least one system module at least partially extends beyond the housing body of the housing. The fuel cell system or the motor vehicle can thus be particularly compact and stable. It is also conceivable that the at least one system module, in particular by means of at least one adapter plate of the fuel cell system, is arranged on the housing body of the housing of the fuel cell system. The at least one adapter plate can preferably comprise lines, tubes, and/or hoses and connections for connecting the at least one system module to the at least one fuel cell stack so as to communicate therewith. The adapter plate is in particular arranged between the at least one system module and the exterior of the housing wall of the housing body.

The communicative connection of the at least one system module to the at least one fuel cell stack can preferably serve to transfer power and/or fluids between the at least one system module and the fuel cell stack and/or the fuel cell system and the motor vehicle. The transmission of data and/or energy can in particular be carried out by means of electrical lines. For example, the transmission of data is a transmission of monitoring data of the fuel cell stack to the fuel cell system or the motor vehicle, respectively. The transmission of energy can be, for example, a transmission of the electrical energy generated by the at least one fuel cell stack from the at least one fuel cell stack to the motor vehicle. The transfer of fluids can in particular be carried out by means of tubes and/or hoses. For example, the transfer of fluids is a transfer of a fuel such as hydrogen, an oxidizer such as air (oxygen), and/or a coolant from the system module to the at least one fuel cell stack or between the system module and the at least one fuel cell stack.

Advantageously, in a fuel cell system according to the invention, the housing body of the housing of the fuel cell system can be arranged on the body of the motor vehicle, on the one hand, and the at least one system module can be arranged on the exterior of the housing wall of the housing body, on the other hand. Thus, the fuel cell system according to the invention can be particularly simple, compact, inexpensive, and efficient.

It can be advantageous for a fuel cell system according to the invention when the housing body of the housing is formed at least in sections, preferably completely, so as to be rigid and/or electrically insulating. Advantageously, a rigid housing body can particularly advantageously protect the at least one fuel cell stack against external mechanical effects, for example, as can occur during a car accident. The rigid housing body can in particular comprise struts, preferably struts in at least one housing wall of the housing body. Further advantageously, an electrically insulating housing body can particularly advantageously prevent an unwanted electrical potential of the fuel cell stack being tappable on the housing body, in particular on the exterior or one of the exteriors of the housing body. An unwanted electrical potential can abut the housing body, for example, due to a technical defect of the at least one fuel cell stack and/or an electrical line. The housing body can comprise metal, and can in particular be made of metal, wherein the metallic housing body can comprise an electrically insulating layer for electrical insulation. The metallic housing body can advantageously be particularly stable and rigid. However, it is also conceivable that the housing body is made of an electrically insulating material, for example a plastic. The plastic housing body can advantageously additionally be particularly light.

With particular advantage, the housing body of the housing can form a support structure, in particular a support structure for the at least one system module arranged on the exterior of the housing wall. In other words, the housing body is configured so as to receive and pass on loads. The fuel cell system can thus be particularly advantageously stable, or the at least one system module can be particularly advantageously arranged on the housing body of the housing, in particular on the exterior of the housing wall.

Advantageously, in a fuel cell system according to the present invention, the at least one system module can be releasably arranged with the system module counter-securing section on the at least one system module securing section of the housing body. Thus, the at least one system module can be assembled and disassembled particularly easily. The releasable arrangement of the system module on the housing body is preferably carried out by means of at least one force-fit and/or form-fit connection, e.g. by means of a bracket, a screw connection, a bolt connection, and/or a snap connection. Furthermore, the at least one system module can be arranged directly on the at least one system module securing section of the housing body, particularly by means of the system module counter-securing section. In other words, the at least one system module having the system module counter-securing section can be arranged on the at least one system module securing section of the housing body such that the system module counter-securing section and the at least one system module securing section at least partially contact one another. Thus, the motor vehicle or the fuel cell system can be configured so as to be particularly compact and stable with the housing body and the at least one system module.

With particular advantage, in a fuel cell system according to the present invention, the at least one system module can comprise, or in particular is, at least a fluid supply module fluidly connected to the at least one fuel cell stack for supplying a fluid to the at least one fuel cell stack, a fluid drainage module fluidly connected to the at least one fuel cell stack for draining a fluid from the fuel cell stack, an electrical module electrically connected to the at least one fuel cell stack for communicating data and/or transmitting an electrical energy generated by the at least one fuel cell stack to the motor vehicle. Advantageously, by arranging a fluid supply module and/or a fluid drainage module and/or an electrical module on the exterior of the housing wall of the housing body, the fuel cell system can be particularly efficient to operate. The fluid supply module can in particular be a fuel supply module, an oxidizer supply module, or a coolant supply module for supplying a fuel, an oxidizer, or a coolant to the at least one fuel cell stack. For example, the oxidizer supply module can comprise an air compressor, an air cooler, a humidifier, and/or air shutoff valves. For example, the fuel supply module can comprise a water separator, an anode recirculation fan, a hydrogen dosing valve, and/or a jet pump. Furthermore, the fluid drainage module can be, in particular, a fuel drainage module, an oxidizer drainage module, or a coolant drainage module for draining a fuel, an oxidizing agent, or a coolant from the at least one fuel cell stack.

Advantageously, in a fuel cell system according to the invention, on at least one system module securing section on the exterior of a further housing wall of the housing body, at least one further system module of the fuel cell system is at least partially arranged, being arranged on the exterior of the housing body and having a system module counter-securing section, wherein in particular the housing wall and the one further housing wall lie opposite one another. Advantageously, the fuel cell system can thus be particularly compact in configuration. It is also conceivable that on at least one system module securing section of two further housing walls of the housing body, at least one respective system module of the fuel cell system is at least partially arranged, being arranged on the exterior of the housing body and having a system module counter-securing section, wherein the housing wall and the two further housing walls substantially form a U shape. Thus, the fuel cell system can be particularly compact and stable.

It can be advantageous for a fuel cell system according to the invention when, on at least one further system module securing section on the exterior of the housing wall of the housing body, a further system module of the fuel cell system is at least partially arranged, being arranged on the exterior of the housing body and having a system module counter-securing section. The at least one system module and the further system module can in particular be arranged so as to be spaced apart from one another on the exterior of the housing wall of the housing body. The fuel cell system, in particular the housing body, can comprise spacers for this spaced arrangement. Thus, advantageously, the at least one system module and the further system module can be assembled or disassembled particularly easily. Furthermore, the convective transport of thermal energy, in particular the natural convection, the at least one system module and/or the further system module and/or the housing body, can be particularly advantageous. Thus, advantageously, the fuel cell system can be particularly efficient.

With particular advantage, in a fuel cell system according to the invention, at least a portion of at least one of the housing walls of the housing body can form a stack end plate and/or an adapter plate of the at least one fuel cell stack. In other words, the stack end plate and/or the adapter plate can in particular form at least part of the at least one housing wall of the housing body. The stack end plate and/or the adapter plate can be arranged on other housing walls, in particular secured to other housing walls, in order to form the housing body. The securing can take place, for example, via force-fit connections, in particular via screw connections. As a result, the stack end plate and/or the adapter plate are part of the support structure and thus take on supporting functions. For example, the stack end plate can be a bottom or top surface of the housing body. The same applies to the adapter plate. Thus, the stack end plate and/or the adapter plate together with the other housing walls form the housing body of the housing. Thus, the fuel cell system can be particularly compact. Preferably, the stack end plate and/or the adapter plate form at least one housing wall of the housing body. It is also conceivable that the adapter plate and the stack end plate arranged one above the other are in particular integrally formed. Furthermore, the stack end plate and the adapter plate can in particular be separate components, wherein preferably the stack end plate and the adapter plate are arranged together to form the at least one portion of the at least one housing wall of the housing body. It is also conceivable that the adapter plate and the stack end plate arranged one above the other are in particular integrally formed. Thus, the housing body can advantageously be particularly simple, in particular because the stack end plate and/or the adapter plate take on supporting functions. In particular, two opposing housing walls of the housing body can each comprise or form a stack end plate and/or adapter plate of the fuel cell stack. Thus, the fuel cell system can be particularly advantageously operated and braced. The stack end plate and/or the adapter plate are integrated into the housing body of the housing and thus support the supporting function of the housing body of the housing. Preferably, the stack end plate and/or the adapter plate have a similar, in particular the same, dimensional stability and strength as the other housing walls of the housing body of the housing.

According to a further preferred embodiment, in a fuel cell system according to the invention, the housing wall of the housing body comprising the at least one system module securing section can form, and in particular comprise, the stack end plate and/or the adapter plate of the at least one fuel cell stack. Thus, the at least one system module, in particular a fuel supply module, can be particularly advantageously connected to the at least one fuel cell stack so as to communicate therewith. Furthermore, advantageously, the fuel cell system can be particularly compact and efficiently operated.

It can be advantageous for a fuel cell system according to the invention to receive and protect at least two fuel cell stacks in the housing body of the fuel cell system, wherein at least a portion of at least one of the housing walls of the housing body forms a stack end plate and/or an adapter plate for the at least two fuel cell stacks. In other words, the stack end plate and/or the adapter plate for the at least two fuel cell stacks can form at least part of the at least one housing wall of the housing body. Preferably, the stack end plate and/or the adapter plate of the fuel cell stack form the at least one housing wall of the housing body. Thus, at least two fuel cell stacks have a common adapter plate that is part of the housing body of the housing. The same applies to the stack end plate. Again, the adapter plate and/or stack end plate can be a bottom or top surface of the housing body, which can receive at least two fuel cell stacks. Again, the stack end plate and/or the adapter plate together with the other housing walls form the housing body of the housing. Thus, the fuel cell system can be particularly compact. In particular, the common adapter plate of the at least two fuel cell stacks and/or the common stack end plate of the at least two fuel cell stacks can be integrally formed. However, it is also conceivable that the common adapter plate of the at least two fuel cell stacks can be formed by combining a separate adapter plate of a fuel cell stack of the at least two fuel cell stacks and a separate adapter plate of the one further fuel cell stack of the at least two fuel cell stacks. The two separate adapter plates can in particular be releasably arranged together for the common adapter plate, for example screwed together by means of screws. The same applies to the common stack end plate. Furthermore, the stack end plate and the adapter plate of the at least two fuel cell stacks can in particular each be arranged one above the other. Thus, the fuel cell system can be further particularly compact and efficiently operated. Furthermore, the stack end plate and the adapter plate can in particular each be separate components, wherein preferably the respective stack end plate and the adapter plate are arranged together to form at least part of the at least one housing wall of the housing body. It is also conceivable that the respective adapter plates and stack end plates arranged one above the other are in particular integrally formed with the at least two fuel cell stacks. The housing body can thus advantageously be particularly simple. Furthermore, the at least one fuel cell stack and the at least one further fuel cell stack can each be particularly advantageously braced by the stack end plate and/or supplied by the adapter plate. In particular, at least a portion of two housing walls of the housing body facing one another can each form a stack end plate and/or an adapter plate of the at least two fuel cell stacks. The stack end plate and/or the adapter plate are integrated into the housing body of the housing, which comprises two or more fuel cell stacks, and thus support the supporting function of the housing body of the housing.

According to a further preferred embodiment, the at least two fuel cell stacks received and protected in the housing body of the fuel cell system can be spatially separated from one another. In particular, the housing, preferably the housing body, can comprise a partition wall for spatially separating the at least one fuel cell stack and the at least one further fuel cell stack in the housing body. Thus, the housing body of the fuel cell system can be particularly rigid and stable. It is also conceivable that the housing body in particular comprises a first separate subhousing body for receiving and protecting the at least one fuel cell stack and a second separate subhousing body of the fuel cell system for receiving and protecting the at least one further fuel cell stack for spatial separation, wherein the housing body is in particular formed by the latter. Preferably, the first subhousing body, in particular at least part of a housing wall of the first subhousing body, and the second subhousing body, in particular at least part of a housing wall of the second subhousing body, can be arranged together, in particular attached to one another, for example screwed together in order to form the housing body of the housing. In particular, the two combined subhousing bodies form a cuboid shape.

According to a second aspect, the present invention discloses a motor vehicle having a body, wherein the motor vehicle comprises a fuel cell system, and wherein the housing body of the housing of the fuel cell system having the at least one motor vehicle securing section is arranged on the body of the motor vehicle.

The body of the motor vehicle can in particular comprise longitudinal and/or transverse beams, wherein the longitudinal and/or transverse beams in particular form a chassis of the motor vehicle. The chassis or the longitudinal and/or transverse beams can comprise at least one motor vehicle counter-securing section for arrangement on the at least one motor vehicle securing section of the housing body of the housing.

The motor vehicle according to the second aspect of the invention thus has the same advantages as have already been described for the fuel cell system according to the first aspect of the invention.

Further measures improving the invention arise from the following description of a few embodiment examples of the invention, which are schematically illustrated in the figures. All of the features and/or advantages arising from the claims, description or drawings, including structural details, spatial arrangements and process steps, can be essential to the invention both by themselves and in the various combinations. It should be noted that the figures have only a descriptive character and are not intended to restrict the invention in any way.

### BRIEF DESCRIPTION OF THE DRAWINGS

The following are shown schematically:

FIG. 1 in a top plan view, an embodiment of a fuel cell system 100 according to the invention,

FIG. 2 in a front view in a vertical section, the embodiment of a fuel cell system 100 according to the invention from FIG. 1,

FIG. 3 in a top plan view, a further embodiment of a fuel cell system 100 according to the invention,

FIG. 4 in a front view in a vertical section, the further embodiment of a fuel cell system 100 according to the invention from FIG. 3,

FIG. 5 in a side view in a vertical section, a further embodiment of a fuel cell system 100 according to the invention,

FIG. 6 in a side view in a vertical section, a further embodiment of a fuel cell system 100 according to the invention,

FIG. 7 in a top plan view, an embodiment of a motor vehicle 200 according to the invention,

FIG. 8 in a top plan view, an embodiment of a motor vehicle 200 according to the invention, and

FIG. 9 in a front view, the embodiment of a motor vehicle 200 according to the invention from FIG. 7.

### DETAILED DESCRIPTION

In the following figures, identical reference numbers are used for the same technical features of different embodiment examples.

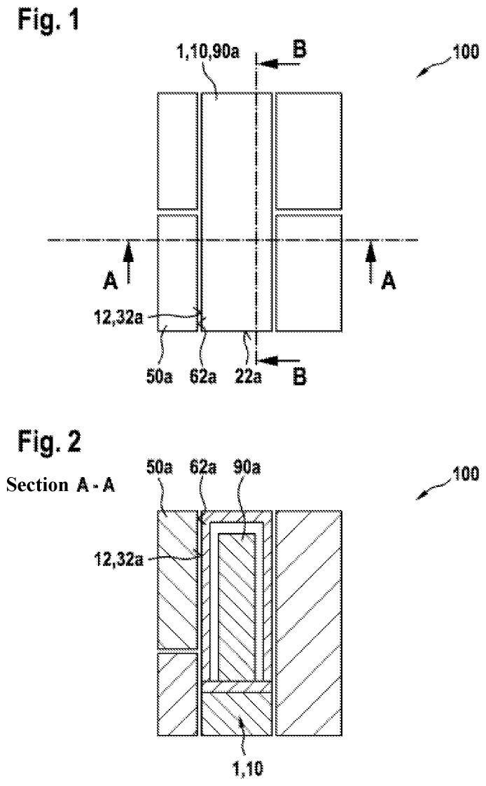

FIG. 1 and FIG. 2 show in a top plan view or in a front view in a vertical section (see section axis A-A in FIG. 1) an embodiment of a fuel cell system 100 according to the invention, having a fuel cell stack 90a in a housing body 10 of a housing 1. The housing body 10 is configured in an exemplary box-shaped fashion and has a system module securing section 32a on the exterior of a housing wall 12. A system module 50a is arranged with a system module counter-securing section 62a on the fastening portion 32a on the exterior of the housing wall 12 to the housing body 10 and is connected to the fuel cell stack 90a (not shown) so as to communicate therewith. Furthermore, the housing body 10 of the housing 1 comprises a motor vehicle securing section 22a for arrangement on a body 202 of a motor vehicle 200. By arranging the system module 50a on the exterior of the housing body 10, the fuel cell system 100 can be particularly compact and, furthermore, the convective transport of thermal energy, in particular the natural convection, of the at least one system module 50a and/or the housing body 10 can be particularly advantageous.

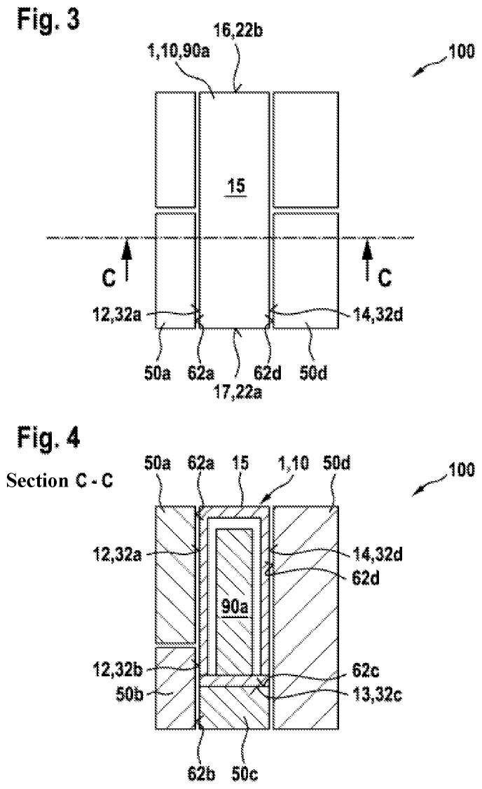

FIG. 3 and FIG. 4 show a further embodiment of a fuel cell system 100 according to the invention in a top view or in a front view in a vertical section (see section axis C-C in FIG. 3). The fuel cell system 100, by way of example, comprises a box-shaped housing body 10 of the housing 1 with a fuel cell stack 90a in the internal space of the housing body 10. The box-shaped housing body 10 comprises six housing walls 12, 13, 14, 15, 16, 17, wherein four housing walls 12, 14, 16 and 17 are in particular side housing walls and two housing walls 13 and 15 are in particular a bottom housing wall or a top housing wall opposite the bottom housing wall. The system module 50a and the system module 50b are each arranged with a system module counter-securing section 62a and 62b, respectively, on a system module securing section 32a and 32b, respectively, on the exterior of the housing wall 12. The system module 50b at least partially projects over the housing body 10. Furthermore, the system module 50c is arranged with a system module counter-securing section 62c on a system module securing section 32c on the exterior of the housing wall 13, in particular on the bottom housing wall. Furthermore, the system module 50d is arranged with a system module counter-securing section 62d on a system module securing section 32d on the exterior of the housing wall 14. The housing body 10 of the fuel cell system 100 further comprises a motor vehicle securing section 22b and 22a on the exterior of two opposed housing walls 16 and 17.

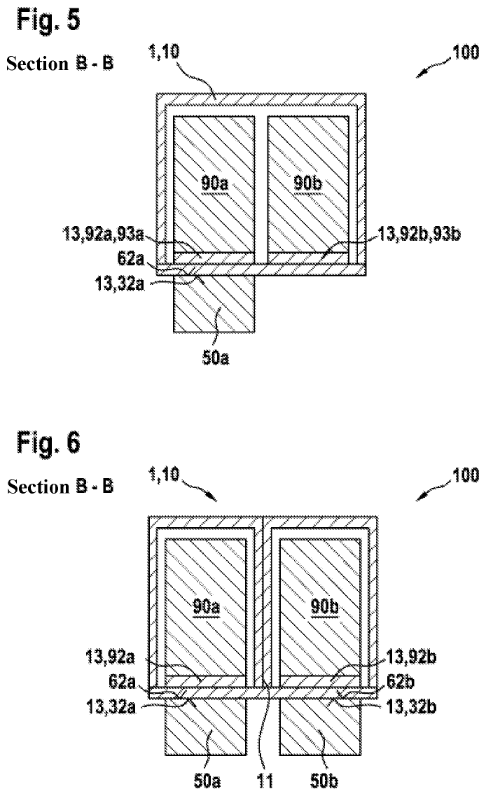

FIG. 5 and FIG. 6 show in a side view in a vertical section (see section axis B-B in FIG. 1) a further embodiment of a fuel cell system 100 according to the invention. In FIG. 5, two fuel cell stacks 90a, 90b are arranged or received in a common housing body 10 of the housing 1 of the fuel cell system 100. Furthermore, a system module 50a having a system module counter-securing section 62a is arranged on the system module securing section 32a of the housing body 10 on the exterior of the housing wall 13, in particular on a bottom housing wall, of the housing body 10, wherein the system module 50a is connected to at least one fuel cell stack 90a, 90b so as to communicate therewith. It is conceivable that, for a plurality of fuel cell stacks 90a, 90b, separate system modules 50a, in particular separate, functionally identical system modules 50a, are arranged on the housing body 10 for each fuel cell stack 90a, 90b. These separate system modules 50a, in particular these separate, functional system modules 50a, are each separately connected to the respective fuel cell stack 90a, 90b of the plurality of fuel cell stacks 90a, 90b so as to communicate therewith. Furthermore, in FIG. 5, the housing wall 13 respectively forms a stack end plate 92a and 92b and an adapter plate 93a and 93b of the two fuel cell stacks 90a and 90b. In particular, the stack end plates 92a and 92b and the adapter plates 93a and 93b are integrally formed with the housing wall 13 of the housing body 10 of the housing 1 of the fuel cell system 100. In other words, the stack end plate 92a and 92b and the adapter plate 93a and 93b of the two fuel cell stacks 90a and 90b form the housing wall 13 of the housing body 10. The stack end plates 92a, 92b and the adapter plates 93a, 93b are arranged on the further housing walls of the housing body 10 so as to form the housing body 10, e.g. via force-fit connections, in particular via screw connections. As a result, the stack end plates 92a, 92b and the adapter plates 93a, 93b are part of the support structure and thus take on supporting functions. That is to say, the stack end plates 92a, 92b and the adapter plates 93a, 93b can receive and pass on loads. Thus, the fuel cell system 100 can be particularly advantageously stable.

In FIG. 6, two fuel cell stacks 90a, 90b are arranged or received in a housing body 10 of the housing 1 of the fuel cell system 100. The housing body 10 comprises a partition wall 11 for separating the one fuel cell stack 90a and the one further fuel cell stack 90b. This partition wall 11 is in particular formed by the housing body 10 having a first subhousing body for receiving and protecting the one fuel cell stack 90a and a second subhousing body for receiving and protecting the one further fuel cell stack 90b. The first subhousing body and the second subhousing body are arranged together on the housing body 10. Furthermore, a system module 50a having a system module counter-securing section 62a is arranged on the system module securing section 32a of the housing body 10 on the exterior of the housing wall 13, in particular on a bottom housing wall, of the housing body 10, wherein the system module 50a is connected to the one fuel cell stack 90a so as to communicate therewith. Furthermore, a system module 50b having a system module counter-securing section 62b is arranged on the system module securing section 32b of the housing body 10 on the exterior of the housing wall 13, in particular on a bottom housing wall, of the housing body 10, wherein the system module 50b is connected to the fuel cell stack 90b so as to communicate therewith. Furthermore, in FIG. 6, the housing wall 13 forms a stack end plate 92a and 92b for the two fuel cell stacks 90a and 90b.

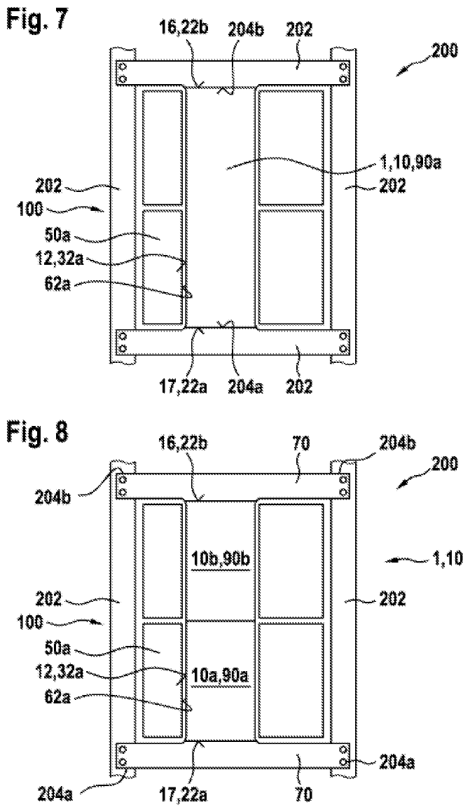

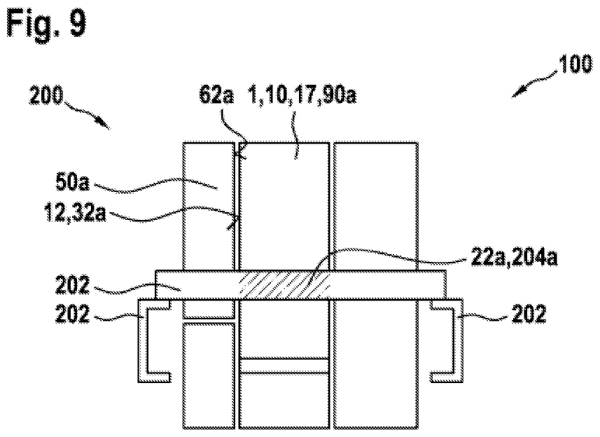

FIG. 7 and FIG. 9 show in a top view or in a front view a further embodiment of a motor vehicle 200 according to the invention, having a fuel cell system 100 according to the invention as already described by way of example in FIG. 1 or FIG. 2. However, the housing body 10 of the fuel cell system 100 has a respective motor vehicle securing section 22b and 22a on the exterior of two opposing housing walls 16 and 17. The housing body 10 is arranged directly on motor vehicle counter-securing sections 204a and 204b of the body 202 of the motor vehicle 200 by way of the motor vehicle securing sections 22a and 22b. The body 202 of the motor vehicle 200 is formed by longitudinal and transverse beams.

FIG. 8 shows in a top plan view a further embodiment of a motor vehicle 200 according to the invention, having a fuel cell system 100 according to the invention, as shown for example in FIG. 1. However, in FIG. 8, the housing body 10 is in particular formed by a first separate subhousing body 10a for receiving and protecting the at least one fuel cell stack 90a and a second separate subhousing body 10b of the housing 1 of the fuel cell system 100 for receiving and protecting the at least one further fuel cell stack 90b. The first subhousing body 10a and the second subhousing body 10b are screwed together, for example, in order to form the housing body 10 of the housing 1. However, the housing body 10 of the fuel cell system 100 has a respective motor vehicle securing section 22b and 22a on the exterior of two opposing housing walls 16 and 17. The housing body 10 is arranged by means of motor vehicle securing sections 22a and 22b indirectly via connecting elements 70 to motor vehicle counter-securing sections 204a and 204b of the body 202 of the motor vehicle 200. The connecting elements 70 can be beams, in particular cross-beams. Furthermore, the connecting elements 70 can in particular belong to the housing 1. In other words, the housing 1 can comprise the connecting elements 70.

1. A fuel cell system (100) of a motor vehicle (200), wherein the fuel cell system (100) comprises:
a. at least one fuel cell stack (90a, 90b) having a plurality of fuel cells,
b. a housing (1) having a housing body (10) for receiving and protecting the at least one fuel cell stack (90a, 90b), wherein the housing body (10) further comprises:
i. at least one motor vehicle securing section (22a, 22b) for arranging the housing body (10) on a body (202) of the motor vehicle (200),
ii. at least one system module securing section (32a, 32b, 32c, 32d) on an exterior of a housing wall (12, 13, 14, 15, 16, 17) of the housing body (10) for arranging at least one system module (50a, 50b, 50c, 50d),
c. the at least one system module (50a, 50b, 50c, 50d) having a system module counter-securing section (62a, 62b, 62c, 62d), wherein the at least one system module (50a, 50b, 50c, 50d) having the system module counter-securing section (62a, 62b, 62c, 62d) is arranged on the at least one system module securing section (32a, 32b, 32c, 32d) of the housing body (10) at least partially on the exterior of the housing wall (12, 13, 14, 15, 16, 17) of the housing body (10), wherein the at least one system module (50a, 50b, 50c, 50d) is connected to the at least one fuel cell stack (90a, 90b) so as to communicate therewith.

2. The fuel cell system (100) according to claim 1, wherein
the housing body (10) of the housing (1) is at least partially rigid and/or electrically insulating.

3. The fuel cell system (100) according to claim 1, wherein
the housing body (10) of the housing (1) forms a support structure, for the at least one system module (50a, 50b, 50c, 50d) arranged on the exterior of the housing wall (12, 13, 14, 15, 16, 17).

4. The fuel cell system (100) according to claim 1, wherein
the at least one system module (50a, 50b, 50c, 50d) having the system module counter-securing section (62a, 62b, 62c, 62d) is releasably arranged on the at least one system module securing section (32a, 32b, 32c, 32d) of the housing body (10).

5. The fuel cell system (100) according to claim 1, wherein
the at least one system module (50a, 50b, 50c, 50d) comprises at least one of the following modules:
a fluid supply module fluidly connected to the at least one fuel cell stack (90a, 90b) for supplying a fluid to the at least one fuel cell stack (90a, 90b),
a fluid drainage module fluidly connected to the at least one fuel cell stack (90a, 90b) for draining a fluid from the fuel cell stack (90a, 90b),
an electrical module electrically connected to the at least one fuel cell stack (90a, 90b) for communicating data and/or transmitting an electrical energy generated by the at least one fuel cell stack (90a, 90b) to the motor vehicle.

6. The fuel cell system (100) according claim 1, wherein
on at least one system module securing section (32a, 32b, 32c, 32d) on the exterior of a further housing wall (12, 13, 14, 15, 16, 17) of the housing body (10), at least one further system module (50a, 50b, 50c, 50d) of the fuel cell system (100) is at least partially arranged, being arranged on the exterior of the housing body (10) and having a system module counter-securing section (62a, 62b, 62c, 62d.

7. The fuel cell system (100) according claim 1, wherein
on at least one further system module securing section (32a, 32b, 32c, 32d) on the exterior of the housing wall (12, 13, 14, 15, 16, 17) of the housing body (10), at least one further system module (50a, 50b, 50c, 50d) of the fuel cell system (100) is at least partially arranged, being arranged on an exterior of the housing body (10) and having a system module counter-securing section (62a, 62b, 62c, 62d).

8. The fuel cell system (100) according to claim 1, wherein
at least a portion of at least one of the housing walls (12, 13, 14, 15, 16, 17) of the housing body (10) forms a stack end plate (92a, 92b) and/or an adapter plate (93a, 93b) of the at least one fuel cell stack (90a, 90b).

9. The fuel cell system (100) according to claim 8, wherein
the housing wall (12, 13, 14, 15, 16, 17) of the housing body (10) comprising the at least one system module securing section (32a, 32b, 32c, 32d) forms the stack end plate (92a, 92b) and/or the adapter plate (93a, 93b) of the at least one fuel cell stack (90a, 90b).

10. The fuel cell system (100) according to claim 1, wherein
at least two fuel cell stacks (90a, 90b) are received and protected in the housing body (10) of the fuel cell system (100) next to one another, wherein at least a portion of at least one of the housing walls (12, 13, 14, 15, 16, 17) of the housing body (10) forms a stack end plate (92a, 92b) and/or an adapter plate (93a, 93b) for the at least two fuel cell stacks (90a, 90b).

11. The fuel cell system (100) according to claim 10, wherein
the at least two fuel cell stacks (90a, 90b) received and protected in the housing body (10) of the fuel cell system (100) are spatially separated from one another.

12. A motor vehicle (200) having a body (202), wherein the motor vehicle (200) comprises a fuel cell system (100) according to claim 1, and wherein the housing body (10) of the housing (1) of the fuel cell system (100) having the at least one motor vehicle securing section (22a, 22b) is arranged on the body (202) of the motor vehicle (200).

13. The fuel cell system according to claim 6, wherein the housing wall (12, 13, 14, 15, 16, 17) and the one further housing wall (12, 13, 14, 15, 16, 17) are opposite one another.

14. The fuel cell system according to claim 11, wherein the at least two fuel cell stacks (90a, 90b) are spatially separated from one another by a partition wall (11) of the housing (1).
